(19) United States
(12) Patent Application Publication
(10) Pub. No.: US 2008/0055519 A1
(43) Pub. Date: Mar. 6, 2008

(54) Transflective Liquid Crystal Display Device

(75) Inventors: Stephane J. Battersby, Haywards Heath (GB); David W. Parker, Salfords (GB); Jason R. Hector, Redhill (GB); John R. Hughes, Horley (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/576,547

(22) PCT Filed: Oct. 5, 2005
(86) PCT No.: PCT/IB05/53273

§ 371 Date: Apr. 3, 2007

(30) Foreign Application Priority Data
Oct. 8, 2004 (GB) 0422347.5

(51) Int. Cl. G02F 1/1335

(52) U.S. Cl. 349/68

(57) ABSTRACT

A transflective display device (1), comprising: an array of transmissive pixels (4) and reflective pixels (12) arranged such that at least one characteristic of an image is different for the image displayed in transmissive mode compared to the image displayed in reflective mode, for example different resolution, or one mode colour and the other mode monochrome, and arranged to switch off a backlight (190) that provides illumination for the transmissive mode responsive to the ambient light level (304) exceeding a threshold level (316). The device may further, or alternatively, be arranged to drive the reflective pixels (12) in an all-black state responsive to the ambient light level (304) falling below the threshold (316). An additional threshold (318) may be used to provide a hysteresis loop (320-321). These arrangements tend to alleviate the effect of mixed transmissive/reflective mode images at medium ambient brightness levels (312) where the brightness level (306) of the reflective mode and the brightness level (308) of the transmissive mode are similar.

The present invention relates to liquid crystal display (LCD) devices, and more particularly, to transflective LCD devices.

Transmissive liquid crystal display (LCD) devices and reflective LCD devices have been known for many years. In transmissive LCD devices, a backlight behind the liquid crystal layer provides the light which is modulated by the liquid crystal layer to provide an image for a user viewing the LCD device. In reflective LCD devices, ambient light falling on the front of the reflective LCD device provides the light which is modulated by the liquid crystal layer to provide an image for a user viewing the LCD device.

More recently, transflective LCD devices have been provided. Transflective LCD devices provide a combined operation of a transmissive mode using light from a backlight behind the liquid crystal layer and a reflective mode using ambient light falling on the front of the LCD device.

As in conventional reflective or transmissive LCD devices, typical transflective LCD devices comprise a plurality of pixels arranged in an array of rows and columns. Each pixel comprises a green sub-pixel, a red sub-pixel and a blue sub-pixel. Each sub-pixel is provided with an opaque reflective electrode (or electrode and reflector layered arrangement) and a transparent transmissive electrode. An aperture is provided in the reflective electrode such that light from the backlight can pass through the aperture area of the sub-pixel so as to exit the device so as to provide the transmissive mode of operation for the sub-pixel. Ambient light is reflected from the reflective electrode area of the sub-pixel (i.e. broadly speaking, the sub-pixel area except for the aperture area) so as to provide the reflective mode of operation of the sub-pixel. Examples of colour transflective LCD devices are described in U.S. Pat. No. 6,501,519 and U.S. Pat. No. 6,734,935

Display applications are requiring ever increasing resolution, e.g. upwards of 100 pixels per cm in the case of a transflective LCD device for use in modern mobile telephones. This trend is expected to continue as products such as mobile telephones become more sophisticated in their video display requirements and so on. However, increased resolution means the size of each pixel is reduced, and in the case of conventional transflective LCD devices this means the transmissive aperture must become very small and hence require high power consumption for an acceptable brightness, and/or a only a reduced brightness compared to lower resolution devices would be provided.

Various approaches have been described for improving fabrication processes so that available space is optimised, but such approaches tend to involve costlier or more complicated fabrication processes. Furthermore, such approaches can inherently only improve matters to a certain extent limited by the fundamental pixel area limits imposed on the reflective part of the pixel area and the transmissive aperture respectively by the level of resolution required.

Another approach known in the field of transmissive LCD devices, as opposed to transflective LCD devices, is to provide the different colours i.e. red, green and blue, from a single pixel area (as opposed to respective sub-pixels) by means of a colour sequential driving approach. A transmissive light source is switched temporally between red, green and blue (instead of being a white light source). Thus only one common pixel area is required rather than three sub-pixel areas for each pixel. An example of a colour sequential LCD device is described in U.S. Pat. No. 5,128,782.

Considering now specifically reflective LCD devices, as opposed to transflective devices, their dependence on ambient light can lead to a problem that in low ambient light conditions the image is of poor quality, e.g. low contrast. To attempt to alleviate this problem, U.S. Pat. No. 5,347,293 discloses reversing the contrast of the reflected image in a reflective LCD device dependent upon the ambient light level.

The present inventors have realised that it would be desirable to provide transflective LCD devices in which an image displayed in reflective mode has some difference to the corresponding image displayed in the transmissive mode. One example is for the image displayed in the reflective mode to be of a different resolution compared to the corresponding image displayed in the transmissive mode. Another example is for the image displayed in the transmissive mode to be colour and the corresponding image displayed in the reflective mode to be monochrome.

The present inventors have further realised that, with such transflective devices, when the ambient light level is what may be termed “of medium brightness”, such that the image displayed in the reflective mode is of similar brightness to that of the corresponding image displayed in the transmissive mode, then the user will tend to see both the different forms of the corresponding image together, i.e. a “mixed image”. (Note that this general problem arises from relatively medium, rather than relatively low, ambient light levels, and is therefore fundamentally different from problems with respect to low ambient light level/contrast in reflective LCD devices, as for example in above mentioned U.S. Pat. No. 5,347,293.) The present inventors have further realised that the occurrence of a mixed image will tend to result in a degradation in the quality of the perceived image, and may even be confusing. This has lead the present inventors to realise it would be desirable to provide transflective LCD devices in which the occurrence or appearance of such mixed images tends to be reduced or eliminated, or their effects tend to be reduced or eliminated.

In a first aspect, the present invention provides a transflective display device, comprising: an array of transmissive pixels and reflective pixels arranged such that at least one characteristic of an image is different for the image displayed in transmissive mode compared to the image displayed in reflective mode; and means arranged to vary the relative image brightness between the transmissive mode and the reflective mode dependent upon the ambient light level when compared to one or more ambient light level thresholds.

The means arranged to vary the relative image brightness between the transmissive mode and the reflective mode may comprise means arranged to switch off a backlight that provides illumination for the transmissive mode responsive to the ambient light level exceeding a first threshold.

The backlight may be switched on when the ambient light level falls below the first threshold.

The backlight may be switched on when the ambient light level falls below a second threshold, the second threshold being lower than the first threshold, thereby providing a hysteresis loop.

The means arranged to vary the relative image brightness between the transmissive mode and the reflective mode may further comprise means for driving the reflective pixels in an all-black state responsive to the ambient light level falling below the first threshold.

The means arranged to vary the relative image brightness between the transmissive mode and the reflective mode further comprises means for driving the reflective pixels in an all-black state responsive to the ambient light level falling below the second threshold, with the reflective pixels being driven in image display mode when the ambient light level exceeds the first threshold.

The means arranged to vary the relative image brightness between the transmissive mode and the reflective mode may comprise means for driving the reflective pixels in an all-black state responsive to the ambient light level falling below a second threshold.

The reflective pixels may be driven in image display mode when the ambient light level exceeds the second threshold.

The reflective pixels may be driven in image display mode when the ambient light level exceeds a first threshold, the first threshold being lower than the second threshold thereby providing a hysteresis loop.

The at least one characteristic may be that the image displayed in transmissive mode is of different resolution to that of the corresponding image displayed in reflective mode.

The at least one characteristic may be that the image displayed in transmissive mode is one of colour or monochrome and the corresponding image displayed in reflective mode is the other of colour or monochrome.

In a further aspect, the present invention provides a transflective display device, comprising: an array of transmissive pixels and reflective pixels arranged such that at least one characteristic of an image is different for the image displayed in transmissive mode compared to the image displayed in reflective mode; and means arranged to switch off a backlight that provides illumination for the transmissive mode responsive to the ambient light level exceeding a first threshold. The transflective display device may comprise means for driving the reflective pixels in an all-black state responsive to the ambient light level falling below the first threshold.

In a further aspect, the present invention provides a transflective display device, comprising: an array of transmissive pixels and reflective pixels arranged such that at least one characteristic of an image is different for the image displayed in transmissive mode compared to the image displayed in reflective mode; and means for driving the reflective pixels in an all-black state responsive to the ambient light level falling below a first threshold.

In a further aspect, the present invention provides a transflective display device, comprising: an array of transmissive pixels and reflective pixels arranged such that at least one characteristic of an image is different for the image displayed in transmissive mode compared to the image displayed in reflective mode, for example different resolution, or one mode colour and the other mode monochrome, and arranged to switch off a backlight that provides illumination for the transmissive mode responsive to the ambient light level exceeding a threshold level. The device may further, or alternatively, be arranged to drive the reflective pixels in an all-black state responsive to the ambient light level falling below the threshold. An additional threshold may be used to provide a hysteresis loop.

The above described aspects of the invention generally tend to alleviate the effect of mixed transmissive/reflective mode images at medium ambient brightness levels where the brightness level of the reflective mode and the brightness level of the transmissive mode are similar.

Embodiments of the present invention will now be described, by way of example, with reference to the accompanying drawings, in which:

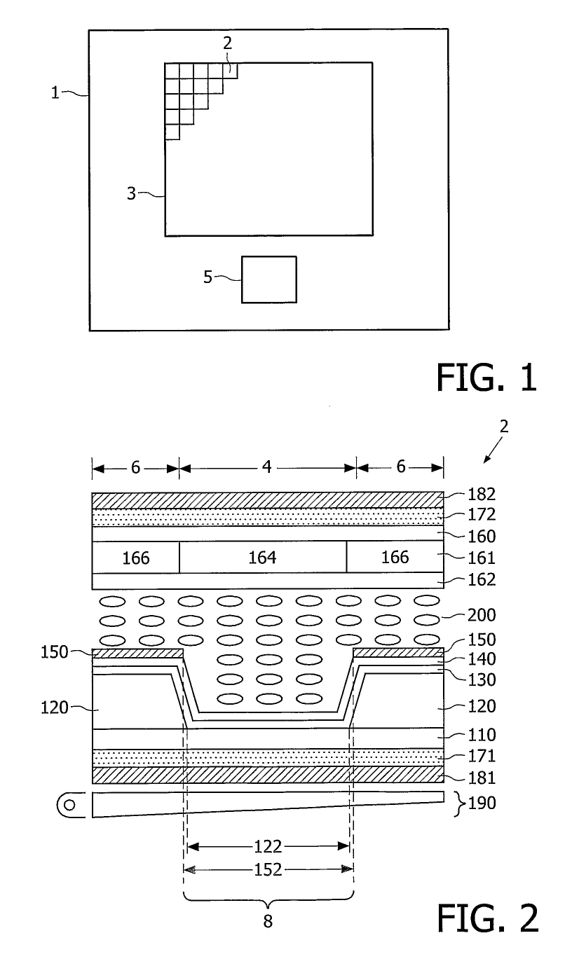

FIG. 1 is a simplified representation of a transflective LCD device;

FIG. 2 is a schematic cross-sectional illustration (not to scale) of one transmissive pixel/reflective sub-pixel of the transflective LCD device of FIG. 1;

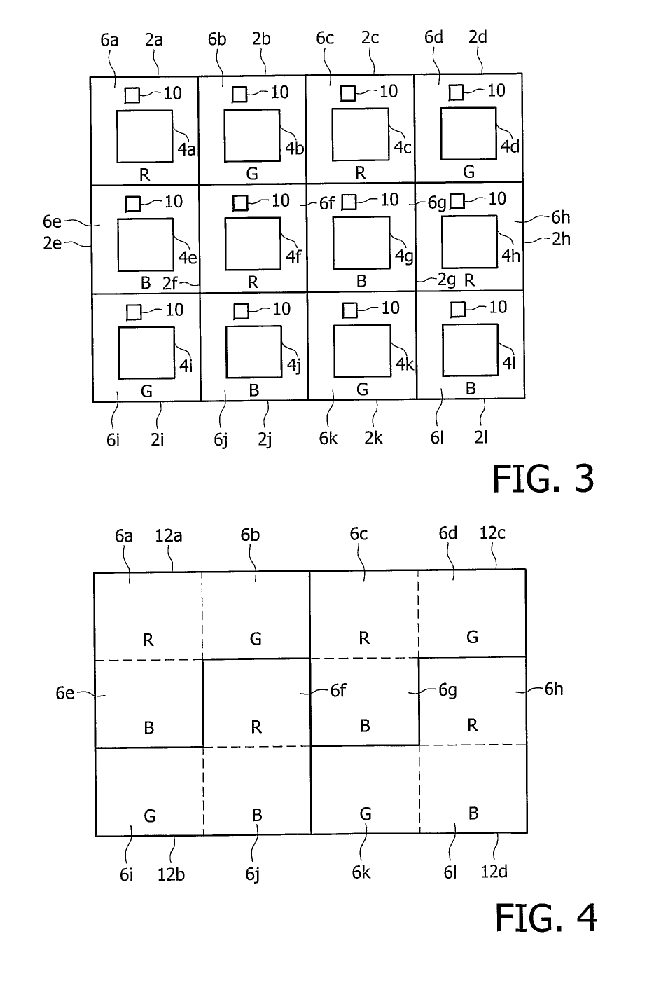

FIG. 3 is a schematic diagram showing the arrangement of transmissive pixel/reflective sub-pixels in the transflective LCD device of FIG. 1;

FIG. 4 is a schematic diagram showing the arrangement of reflective colour pixels 12a-12d in the transflective LCD device of FIG. 1;

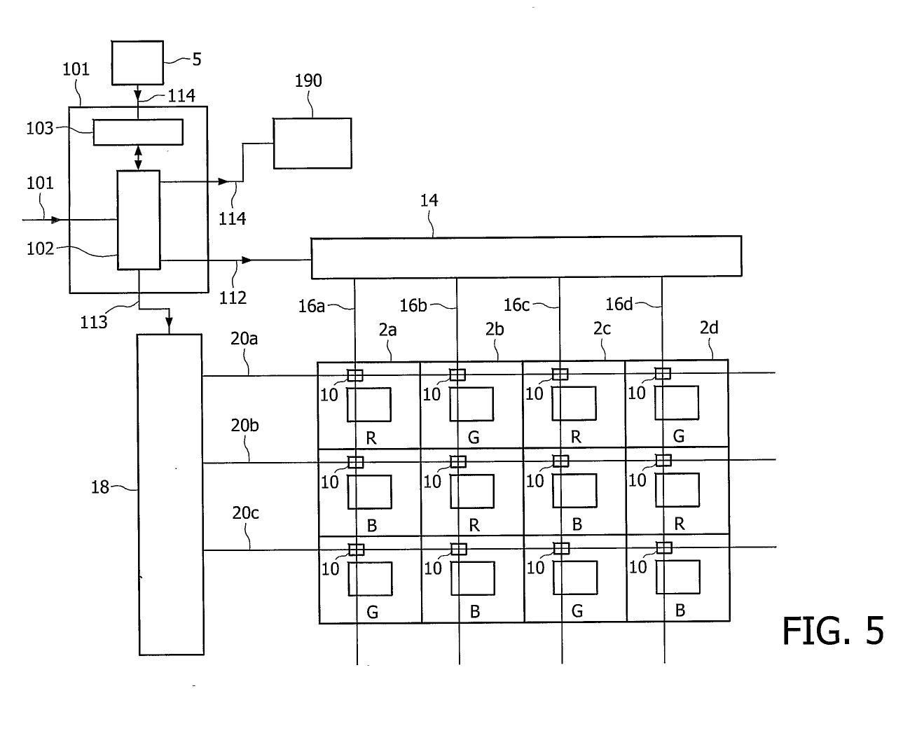

FIG. 5 is a schematic diagram showing in simplified form the driving connections and control circuitry employed in the transflective LCD device of FIG. 1;

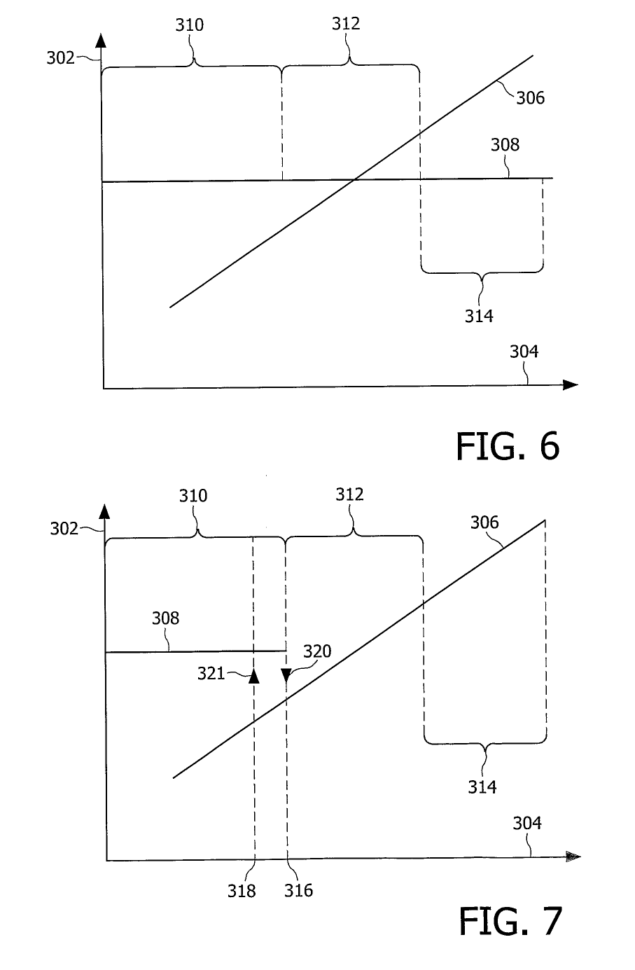

FIG. 6 is a schematic (not to scale) illustration of the image brightness of a corresponding image as displayed by a conventional transflective LCD device in reflective mode and in transmissive mode as a function of ambient light;

FIG. 7 is a schematic (not to scale) illustration of the image brightness of a corresponding image as displayed by the transflective LCD device of FIG. 1 in reflective mode and in transmissive mode as a function of ambient light;

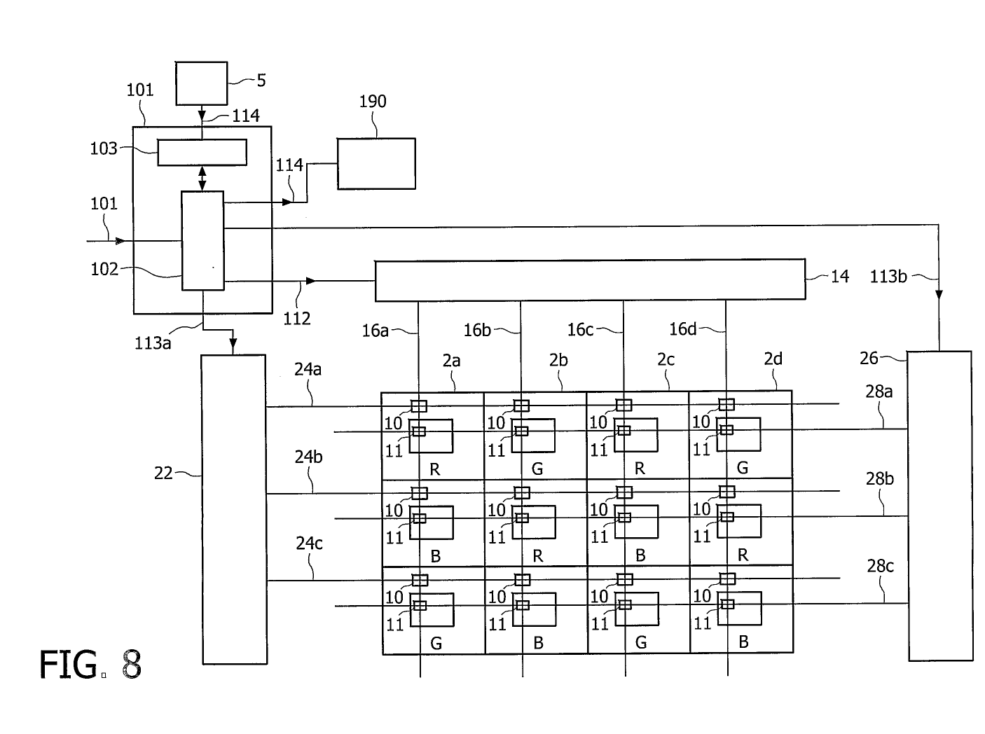

FIG. 8 is a schematic diagram showing in simplified form the driving connections and control circuitry employed in a further transflective LCD;

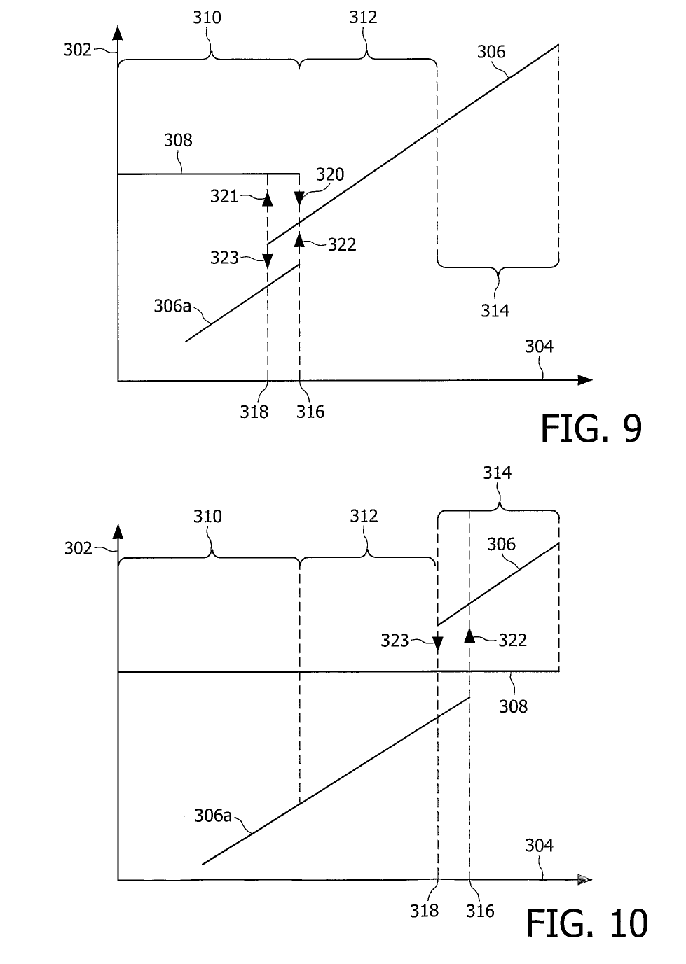

FIG. 9 is a schematic (not to scale) illustration of the image brightness of a corresponding image as displayed by the transflective LCD device of FIG. 8 in reflective mode and in transmissive mode as a function of ambient light;

FIG. 10 is a schematic (not to scale) illustration of the image brightness of a corresponding image as displayed by the transflective LCD device of FIG. 8 in reflective mode and in transmissive mode as a function of ambient light.

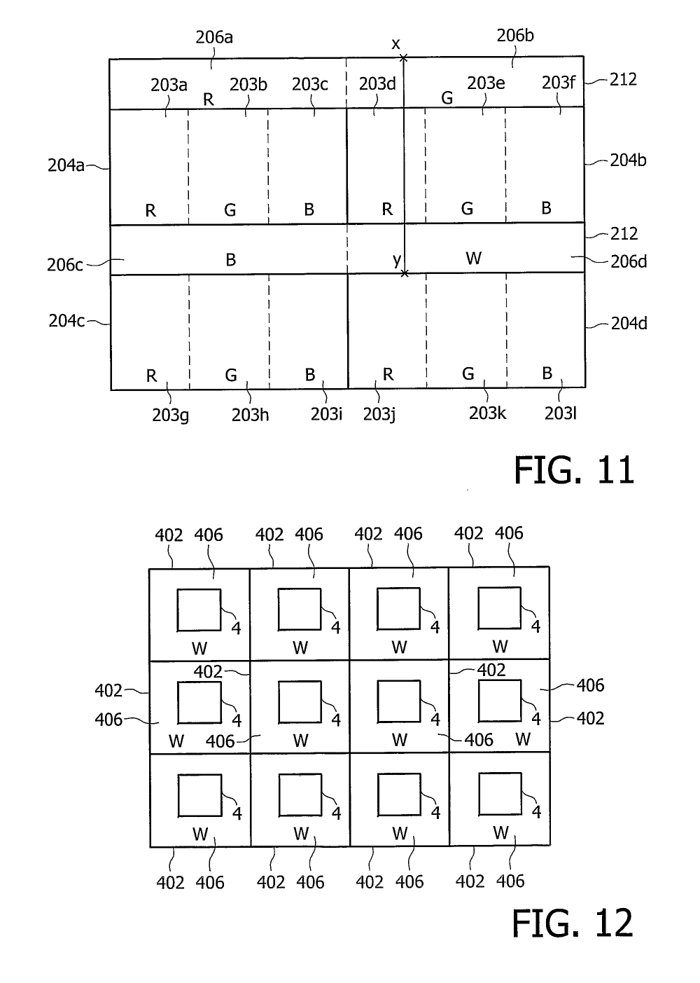

FIG. 11 is a schematic diagram showing the arrangement of sub-pixels in an example of a transflective LCD device with differently coloured transmissive sub-pixels; and

FIG. 12 is a schematic diagram showing the arrangement of pixels in an example of a transflective LCD device in which the transmissive mode image is colour and the reflective mode image is monochrome.

FIG. 1 is a simplified representation of a transflective LCD device 1 according to the first embodiment. The transflective LCD device 1 comprises a transflective LCD panel 3 and a photodiode 5. The transflective LCD panel comprises a large number of transmissive pixels/reflective sub-pixels 2 arranged in an array of rows and columns, in this example 150 rows by 500 columns (for clarity only some of these are shown in FIG. 1). Each transmissive pixel/reflective sub-pixel 2 comprises a transmissive pixel surrounded by a reflective sub-pixel, as will be explained in more detail below with reference to FIGS. 2-5. The operation of the transflective LCD panel 3, in particular the driving of the transmissive pixels and the reflective sub-pixels, is controlled in a manner dependent upon the ambient light level sensed by the photodiode 5, as will be explained in more detail below with reference to FIGS. 5-7.

FIG. 2 is a schematic cross-sectional illustration (not to scale) of one transmissive pixel/reflective sub-pixel 2 of the transflective LCD panel 3. The transmissive pixel/reflective sub-pixel 2 comprises a first approximately central area which effectively constitutes the transmissive pixel 4 and an area surrounding the central area which effectively constitutes the reflective sub-pixel 6.

The transflective LCD device has a lower substrate 110 and an upper substrate 160 facing apart from each other. A first passivation layer 120 is formed on the inner surface of the lower substrate 110, and the first passivation layer 120 has a first transmissive hole 122 in the area corresponding to the transmissive pixel 4. A transmissive electrode 130 of a transparent conductive material is formed on the first passivation layer 120. Next, a second passivation layer 140 is formed on the transmissive electrode 130, and a reflective electrode 150 is formed on the second passivation layer 140. The reflective electrode 150 has a second transmissive hole 152 exposing the transmissive electrode 130 on the first transmissive hole 122.

A thin film transistor (TFT) (not shown) is formed on the inner surface of the lower substrate 110, and the TFT is connected electrically to the transmissive electrode 130 and the reflective electrode 150.

A colour filter layer 161 is formed on the inner surface of the upper substrate 160 and a common electrode 162 is formed on the colour filter 161 layer. In the area of the transmissive pixel 4, the colour filter layer 161 is transparent, providing a transparent window 164 which does not affect the colour of the light transmitted through it. In the area of the reflective sub-pixel 6, the colour filter layer 161 is coloured to provide the conventional colour filter 166 of the reflective sub-pixel, i.e. red, green or blue as will be explained in more detail below.

Next, retardation films 171 and 172 are arranged on the outer surface of the lower and upper substrates 110 and 160, respectively. Polarizers 181 and 182 are arranged on the outer surface of the respective retardation film 171 and 172.

A backlight 190 is located under the lower polarizer 181 and extends over the whole array of pixels; however this is shown schematically in FIG. 2 as being specifically under the sub-pixel 2. The backlight is one which can be driven sequentially in different colours, here red, green and blue. Any suitable colour sequential backlight and corresponding driver apparatus may be employed. In this example, apparatus such as that described in U.S. Pat. No. 5,128,782, the contents of which are contained herein by reference, is used.

A liquid crystal layer 200 is disposed between the reflective electrode 150 and the common electrode 162. The liquid crystal molecules of the liquid crystal layer 200 are arranged horizontally with respect to the substrates 110 and 160. The liquid crystal layer 200 has a positive permittivity anisotropy value, so the liquid crystal molecules are arranged parallel to a direction of the electric field induced between the reflective electrode 150 and the common electrode 162 when voltage is applied to the electrodes 130, 150 and 162.

A phase difference of the liquid crystal layer depends on the refractive index anisotropy value (An) and the thickness (d) of the liquid crystal layer. Therefore, the phase difference of the liquid crystal layer can be controlled by changing the thickness of the liquid crystal layer.

Accordingly, as shown in FIG. 2, the first passivation layer 120 has a first transmissive hole 122 so that the brightness in the transmissive mode and the reflective mode may be made uniform. In this example the liquid crystal layer 200 in the transmissive region 4 has twice the thickness of the liquid crystal layer 200 in the reflective region 6.

The first transmissive hole 122 and the second transmissive hole 152 together effectively provide an aperture 8 that allows the transmissive mode of operation of the transmissive pixel 4 with the backlight 190 as the transmissive light source.

FIG. 3 is a schematic diagram showing the arrangement of transmissive pixel/reflective sub-pixels 2 in the transflective LCD device of this embodiment. Twelve transmissive pixel/reflective sub-pixels 2a-2l, each of the form of the transmissive pixel/reflective sub-pixel 2 described above with reference to FIG. 2, are shown by way of example, i.e. each transmissive pixel/reflective sub-pixel 2a-2l comprises a respective transmissive pixel 4a-4l and a respective reflective colour sub-pixel 6a-6l. The transmissive pixel/reflective sub-pixels 2a-2l are arranged in rows and columns. In more detail, transmissive pixel/reflective sub-pixels 2a-2d are in a first row, transmissive pixel/reflective sub-pixels 2e to 2h are in a second row directly under the first row, and transmissive pixel/reflective sub-pixels 2i-2l are in a third row directly under the second row; hence transmissive pixel/reflective sub-pixels 2a, 2e and 2i are in a first column, transmissive pixel/reflective sub-pixels 2b, 2f and 2j are in a second column next to the first column, transmissive pixel/reflective sub-pixels 2c, 2g and 2k are in a third column next to the second column, and transmissive pixel/reflective sub-pixels 2d, 2h and 2l are in a fourth column next to the third column.

The colours of the reflective colour sub-pixels 6a-6l are arranged as follows. The first sub-pixel in the first row, i.e. sub-pixel 6a is red, and the next sub-pixel in the first row, i.e. sub-pixel 6b is green. This alternation between red and green is continued across the row, i.e. the next sub-pixel in the first row, i.e. sub-pixel 6c is red, the next sub-pixel in the first row i.e. sub-pixel 6d is green, and so on. Turning now to the second row, the first sub-pixel in the second row, i.e. sub-pixel 6e is blue, and the next sub-pixel in the second row, i.e. sub-pixel 6f is red. This alternation between blue and red is continued across the row, i.e. the next sub-pixel in the second row, i.e. sub-pixel 6g is blue, the next sub-pixel in the second row i.e. sub-pixel 6h is red, and so on. Turning now to the third row, the first sub-pixel in the third row, i.e. sub-pixel 6i is green, and the next sub-pixel in the third row, i.e. sub-pixel 6j is blue. This alternation between green and blue is continued across the row, i.e. the next sub-pixel in the third row, i.e. sub-pixel 6k is green, the next sub-pixel in the third row i.e. sub-pixel 6l is blue, and so on.

The reflective colour sub-pixels are arranged as described in the preceding paragraph so as to provide an efficient layout of reflective colour pixel, as will now be described with reference to FIG. 4. FIG. 4 is a schematic diagram showing the arrangement of reflective colour pixels 12a-12d in the transflective LCD device of this embodiment. Each reflective colour pixel 12a-12d comprises one red, one green and one blue reflective colour sub-pixel of the above described sub-pixels 6a-6l (in FIG. 4 the outline of the reflective colour pixels is shown in bold line, whereas the distinction between respective reflective colour sub-pixels is shown in dashed line). In each pixel, two sub-pixels are from a given row and the third sub-pixel is from an adjoining row. In more detail, a first reflective colour pixel 12a comprises the first (red) sub-pixel 6a of the first row, the adjacent green sub-pixel 6b of the first row, and the first (blue) sub-pixel 6e of the second row which is furthermore in the same column (the first column) as the first (red) sub-pixel 6a. A second reflective colour pixel 12b comprises the second sub-pixel of the second row, i.e. the red sub-pixel 6f, and the first and second sub-pixels of the third row, i.e. the green sub-pixel 6i and the blue sub-pixel 6j. It can be seen that these two pixels 12a and 12b form an interlocking pattern. This pattern is repeated throughout the array, for example as shown in FIG. 4, a third reflective colour pixel 12c comprises the third and fourth sub-pixels of the first row, i.e. the red sub-pixel 6c and the green sub-pixel 6d, and the third sub-pixel of the second row, i.e. the blue sub-pixel 6g; and a fourth reflective colour pixel 12d comprises the fourth sub-pixel of the second row, i.e. the red sub-pixel 6h, and the third and fourth sub-pixels of the third row, i.e. the green sub-pixel 6k and the blue sub-pixel 6l. This arrangement (as opposed to positioning all the four sub-pixels of a given reflective sub-pixel across a single row) in effect “shares” the lower resolution of the reflective mode between the vertical and the horizontal resolutions, thereby tending to improve the perception of the image to a user.

The resolution of the transmissive mode is three times that of the reflective mode. By implementing this differing resolution between the modes it is possible to provide full colour display in the reflective mode as well as the transmissive mode, whilst making full use of the three-fold increase in resolution offered in the transmissive mode by use of the colour sequential driving approach. This is surprisingly beneficial, inter alia because of the realisation by the present inventor that such improved resolution is primarily desired in the transmissive mode as opposed to in the reflective mode.

Returning to FIG. 3, the TFT of each transmissive pixel/reflective sub-pixel mentioned (but not shown) with respect to FIG. 2 is shown schematically in FIG. 3 as a respective TFT 10 located at each transmissive pixel/reflective sub-pixel 2a-2l, i.e. in this embodiment a single TFT 10 is shared by the transmissive pixel part and the reflective sub-pixel part of each transmissive pixel/reflective sub-pixel 2, by virtue of the TFT 10 being electrically connected to both transmissive electrode 130 and the reflective electrode 150 as described earlier with reference to FIG. 2, and which will be described in more detail with reference to FIG. 5 below.

Other details of the transflective LCD device, except where otherwise stated in relation to the use of the colour sequential backlight, control of driving in response to the ambient light level, the association of reflective colour sub-pixels with transmissive pixels, and the driving thereof, may be as per any conventional transflective LCD device, and are in the present embodiment, and other embodiments herein described, the same as, and operate the same as, the transflective LCD device disclosed with reference to FIG. 2 of U.S. Pat. No. 6,734,935, the contents of which are contained herein by reference.

FIG. 5 is a schematic diagram showing in simplified form the driving connections and control circuitry employed in the transflective LCD device 1 of this embodiment.

The control circuitry comprises a device controller 101, a column driver 14 and a row driver 18. The device controller comprises a processor 102 and an ambient light level module 103. The ambient light level module 103 is coupled to the photodiode 5 and the processor 102. The processor 102 is further coupled to the column driver 14, the row driver 18 and the backlight 190. the processor is further arranged for receiving a video signal 101 defining the image to be displayed.

The column driver 14 is connected to the TFTS 10 via column conductors 16a-16d, each column conductor 16a-16d being connected to each of the TFTs 10 of a respective column of transmissive pixel/reflective sub-pixels 2a-2l. The column driver 14 comprises a digital shift register (not shown) and a digital-to-analogue (D/A) converter (not shown) for each column conductor 16a-16d.

The row driver 18 is connected to the TFTS 10 via row conductors 20a-16c, each row conductor 20a-20c being connected to each of the TFTs 10 of a respective row of transmissive pixel/reflective sub-pixels 2a-2l.

In operation, the processor 102 processes the received video signal, and perform timing control operations 101 to provide column driver data 112 to the column driver 14 and a row driver control signal 113 to the row driver 18.

The row driver 18 selects one row of transmissive pixel/reflective sub-pixels 2a-2l at a time, and the column driver provides data signal levels to the columns in synchronisation therewith. Thus in this embodiment, the row driver 18 carries out the row selection driving for both the transmissive mode and the reflective mode of operation such that the transmissive pixels and reflective sub-pixels are driven with the same data as each other, i.e. provide the corresponding or same images but of different resolution.

Also, the processor 102 provides a backlight control signal 114 to the backlight 190. The backlight control signal 114 includes timing and control data for controlling the colour sequential drive operation of the backlight, the switching of the backlight between red, green and blue in synchronisation with the driving of the rows and columns. The backlight control signal 114 further comprises instructions for the backlight 190 to be switched off or on according to the ambient light level as sensed by the photodiode 5, as will be explained in more detail below.

The photodiode provides an ambient light level signal 114 to the ambient light level module 103. The ambient light level module 103 and the processor 102 function in conjunction with each other to compare the ambient light level signal 114 to one or more threshold levels. The part of the backlight control signal 114 specifying whether the backlight should be turned on or off is determined according to the outcome of this comparison, as will be explained in more detail below, in particular with reference to FIG. 7.

The ambient light level module 113 may consist of one or more discrete entities added to a conventional device controller 101 (or at least a device controller adapted for performing colour sequential drive for the transmissive pixels, but otherwise the same as a conventional device controller), and may be implemented as hardware or software or a combination of these. The ambient light level module 103 may alternatively be formed by adapting existing parts of a conventional device controller 101 (or at least a device controller adapted for performing colour sequential drive for the transmissive pixels, but otherwise the same as a conventional device controller), for example by additional programming of the main processor 102, or other processors employed in the device controller.

The switching off or on of the backlight 190, according to the ambient light level as sensed by the photodiode 5, will be explained in more detail below with reference to FIG. 7. However, as this is best understood by comparison to conventional operation which does not take account of ambient light, such conventional operation will first explained with reference to FIG. 6.

FIG. 6 is a schematic (not to scale) illustration of the image brightness of a corresponding image as displayed by a conventional transflective LCD device in reflective mode and in transmissive mode as a function of ambient light. In more detail, the ordinate 302 is image brightness, and the abscissa 304 is the ambient light level.

The image brightness of the reflective mode is shown by a plot 306. The image brightness of the transmissive mode is shown by a plot 308. Each of these are shown as linear, i.e. an idealised form, although in practise variations from linear will usually be present according to characteristics of device components and design. The image brightness 306 of the reflective mode increases with increasing ambient light level, since the brighter the ambient light, the more light is reflected for a given intensity pixel setting. The image brightness 308 of the transmissive mode is constant, i.e. independent of ambient light level, as its brightness is provided by the backlight 190.

For the purpose of this description, it is convenient to consider the ambient light level range as being divided into three ranges, namely a low ambient light level range 310, a medium ambient light level range 312 (which is either side of the ambient light level at which the reflective and transmissive image brightnesses cross over each other), and a high ambient light level range 314, as shown in FIG. 6. These ranges are not absolute, and are effectively a function of user perception and the absolute level of the brightness of the transmissive mode. In the low ambient light level range 310, the image brightness 306 of the reflective mode is considerably lower than the image brightness 308 of the transmissive mode. Hence, in the low ambient light level range 310, the image perceived by the user is effectively only that of the transmissive mode, or at least is dominated by the transmissive mode form, so that the user is satisfied with the overall image. Also, in the high ambient light level range 314, the image brightness 306 of the reflective mode is considerably higher than the image brightness 308 of the transmissive mode. Hence, in the high ambient light level range 310, the image perceived dominated by the reflective mode form, so that the user is again satisfied with the overall image.

However, in the medium ambient light level range 312 the image brightness 306 of the reflective mode is similar to that of the image brightness 308 of the transmissive mode. Hence, in this conventional arrangement, in the medium ambient light level range 310 the image perceived by the user is effectively a mixed image comprising a mixture of the reflective mode form of the image and the transmissive mode form of the image. Due to the differences in these images, i.e. in this embodiment different resolutions, a confusing or unsatisfactory overall image is displayed to the user.

FIG. 7 is a schematic (not to scale) illustration of the image brightness of a corresponding image as displayed by the transflective LCD device of this embodiment in reflective mode and in transmissive mode as a function of ambient light. FIG. 7 is laid out in the same form as FIG. 6, and the same elements are indicated by the same reference numerals.

In this embodiment, the processor 102 and ambient light module 103 operate to switch the backlight 190 off when the ambient light level 304 equals or exceeds a predetermined first threshold 316. In this example, the first threshold is set at the start of the medium ambient light level range 312. With the backlight switched off, the image brightness 308 of the transmissive mode is zero, hence the overall image is now provided by just the reflective mode image, i.e. the overall image displayed is no longer a potentially problematic mixed image, despite the ambient light level 304 being in the medium ambient light level range 312.

Also, the processor 102 and ambient light module 103 operate to switch the backlight 190 back on when the ambient light level 304 falls below a predetermined second threshold 318. In this example, the second threshold 318 is set a little lower than the first threshold 316, i.e. is near the top end of the low ambient light level range 310. With the backlight 190 switched on, the image brightness 308 of the transmissive mode dominates that of the overall image, providing a relatively acceptable overall image.

The processor 102 and ambient light module 103 operate to switch the backlight 190 off and on in this fashion as the ambient light level varies. By setting the second threshold 318 lower than the first threshold 316, a hysteresis loop (indicated in FIG. 7 by the arrows 320 and 321) for switching the backlight 190 on and off is provided. This hysteresis loop 320-321 avoids or reduces excessive on and off switching taking place at ambient light levels very close to the first threshold and/or due to noise levels.

In this embodiment, the first threshold 316 may conveniently be termed a “backlight-off” threshold, and the second threshold 318 may conveniently be termed a “backlight-on” threshold.

It is further noted that the ambient light level ranges 310-314 discussed above are subjective ranges introduced to aid understanding, and as such do not represent absolute light levels to which the first threshold 316 and the second threshold 318 must be fixed. On the contrary, the thresholds may be set at any suitable levels by the skilled person implementing the transflective LCD device, according to application and design considerations.

In other embodiments, the processor 102 may additionally adapt the column driver data 112 and/or the row driver control signal 113 whenever the backlight is switched off so as to provide a form of the image adapted for display in the reflective mode.

FIG. 8 is a schematic diagram showing in simplified form the driving connections and control circuitry employed in a transflective LCD device 1 of a further embodiment. In this further embodiment, the transflective LCD device 1 is the same as that described above in the first embodiment, except for the provision of additional TFTs, different row drivers, and different row conductors, and different driving of the reflective sub-pixels 6a-6l in low ambient light levels, as will now be explained in more detail. In this embodiment, as shown in FIG. 8, in addition to the earlier described TFTs 10 which in this embodiment are provided for just the reflective sub-pixels 6a-6l (i.e. a respective TFT 10 is provided for each reflective sub-pixel 6a-6l by virtue of each respective TFT 10 being electrically connected to a respective reflective electrode 150), a respective TFT 11 is provided for each transmissive pixel 4a-4l by virtue of each respective TFT 11 being electrically connected to a respective transmissive electrode 130.

Furthermore, separate row drivers are provided for driving the TFTs 10 of the reflective sub-pixels 6a-6l compared to the TFTs 11 of the transmissive pixels 4a-4l. In more detail, a reflective mode row driver 22 and a separate transmissive mode row driver 26 are provided. In operation, the processor 102 provides a reflective mode row driver control signal 113a to the reflective mode row driver 22 and a transmissive mode row driver control signal 113b to the transmissive mode row driver 26. The reflective mode row driver is connected to the reflective sub-pixel TFTS 10 via reflective mode row conductors 24a-24c. The transmissive mode row driver 26 is connected to the transmissive pixels 4a-4l via separate transmissive mode row conductors 28a-28c. In operation the use of separate row drivers 22 and 26 for the reflective mode and transmissive mode respectively allows the transmissive pixels to be driven with different data compared to the reflective sub-pixels, i.e. provide separate images which may be adapted to suit the respective differing resolutions and modes.

The use of separate driving for the transmissive pixels compared to the reflective sub-pixels is further exploited to provide a further difference over the first embodiment, as will now be explained with reference to FIG. 9.

FIG. 9 is a schematic (not to scale) illustration of the image brightness of a corresponding image as displayed by the transflective LCD device 1 of this embodiment in reflective mode and in transmissive mode as a function of ambient light. FIG. 9 is laid out in the same form as FIGS. 6 and 7, and the same elements are indicated by the same reference numerals.

In this further embodiment, the processor 102 and ambient light module 103 again operate to switch the backlight 190 off when the ambient light level 304 equals or exceeds a predetermined first threshold 316. In this further embodiment, this threshold 316 is again set at the start of the medium ambient light level range 312. With the backlight switched off, the image brightness 308 of the transmissive mode is zero, hence the overall image is now provided by just the reflective mode image, i.e. the overall image displayed is no longer a potentially problematic mixed image, despite the ambient light level 304 being in the medium ambient light level range 312.

Also, the processor 102 and ambient light module 103 again operate to switch the backlight 190 back on when the ambient light level 304 falls below a predetermined second threshold 318. In this example, the second threshold 318 is again set a little lower than the first threshold 316, i.e. is near the top end of the low ambient light level range 310. With the backlight 190 switched on, the image brightness 308 of the transmissive mode dominates that of the overall image, providing a relatively acceptable overall image.

The processor 102 and ambient light module 103 again operate to switch the backlight 190 off and on in this fashion as the ambient light level varies. By again setting the second threshold 318 lower than the first threshold 316, a hysteresis loop (indicated in FIG. 7 by the arrows 320 and 321) for switching the backlight 190 on and off is again provided. This hysteresis loop 320-321 again avoids or reduces excessive on and off switching taking place at ambient light levels very close to the first threshold and/or due to noise levels.

In this further embodiment, the processor 102 and ambient light module 103 also operate to drive all the reflective sub-pixels 6a-6l into the black state when the ambient light level 304 falls below the second threshold 318, i.e. when the backlight is on. This decreases the image brightness 306 of the reflective mode (as shown by blackened reflective mode image brightness portion 306a in FIG. 9) for ambient light levels below the second threshold 318, which consequently increases the domination of the image brightness 308 of the transmissive mode over the reflective mode brightness, thus further alleviating any tendency for a mixed image to be perceived even at lower ambient light levels. This is particularly beneficial near the second threshold 318.

Also, the processor 102 and ambient light module 103 operate to resume image driving of the reflective sub-pixels 6a-6l (i.e. as opposed to driving them in the black state) when the ambient light level 304 equals or exceeds the first threshold 316, i.e. when the backlight 190 is switched off. This provides the desired reflective mode image in high ambient light conditions.

By virtue of the second threshold 318 being lower than the first threshold 316, a hysteresis loop (indicated in FIG. 7 by the further arrows 322 and 323) is also provided for this switching of the reflective mode between an all-black display state and the normal image display state. As with the backlight switching hysteresis loop 320-321, this reflective mode hysteresis loop 322-323 avoids or reduces excessive switching taking place at ambient light levels very close to the first threshold and/or due to noise levels.

As with the first embodiment, the first threshold 316 and the second threshold 318 may be set at any suitable levels by the skilled person implementing the transflective LCD device, according to application and design considerations.

Also, in this further embodiment, the first threshold 316 may now conveniently be termed a “backlight-off/reflective-image-on” threshold, and the second threshold 318 may now conveniently be termed a “backlight-on/reflective-image-off” threshold.

Another further embodiment will now be described. In this embodiment, the transflective LCD device 1, including the driving connections and control circuitry, is the same as described with reference to FIGS. 8 and 9, except that in this embodiment switching of the reflective mode between an all-black display state and the normal image display state is implemented, but switching off the backlight is not implemented.

FIG. 10 is a schematic (not to scale) illustration of the image brightness of a corresponding image as displayed by the transflective LCD device 1 of this embodiment in reflective mode and in transmissive mode as a function of ambient light. FIG. 10 is laid out in the same form as FIGS. 6 and 7, and the same elements are indicated by the same reference numerals.

As shown in FIG. 10, the backlight is driven for all ambient light conditions.

In this embodiment, the second threshold 318 is set at the top end of the medium ambient light level range 312, and the first threshold 316 is set a little way into the high ambient light level range 314. The processor 102 and ambient light module 103 operate to drive all the reflective sub-pixels 6a-6l into the black state when the ambient light level 304 falls below the second threshold 318. This decreases the image brightness 306 of the reflective mode (as shown by blackened reflective mode image brightness portion 306a in FIG. 10) for ambient light levels below the second threshold 318. As in the previous embodiment, this consequently increases the domination of the image brightness 308 of the transmissive mode over the reflective mode brightness in the low ambient light level range 310, reducing any tendency for a mixed image to be perceived at lower ambient light levels. Moreover, in this embodiment, the tendency or effect of a mixed image in the medium ambient light range 312 is also reduced by operating the reflective sub-pixels in the black state, thereby rendering the transmissive mode brightness higher than that of the reflective mode throughout the medium ambient light level range 312, say. Thus, the effects of a mixed image are reduced, albeit at the expense of a trade-off with reduced overall image brightness.

Also, the processor 102 and ambient light module 103 operate to resume image driving of the reflective sub-pixels 6a-6l (i.e. as opposed to driving them in the black state) when the ambient light level 304 equals or exceeds the first threshold 316. This re-instates the reflective mode image in high ambient light conditions, where the reflective mode image is able to dominate the transmissive mode image.

By virtue of the second threshold 318 being lower than the first threshold 316, a hysteresis loop (indicated in FIG. 10 by the arrows 322 and 323) is again provided for this switching of the reflective mode between an all-black display state and the normal image display state, which again avoids or reduces excessive switching taking place at ambient light levels very close to the first threshold and/or due to noise levels.

As with the first embodiment, the first threshold 316 and the second threshold 318 may be set at any suitable levels by the skilled person implementing the transflective LCD device, according to application and design considerations.

Also, in this further embodiment, the first threshold 316 may now conveniently be termed a “reflective-image-on” threshold, and the second threshold 318 may now conveniently be termed a “reflective-image-off” threshold.

In the above embodiments, the transmissive pixels are provided with different colours by being driven in a colour sequential manner. In further embodiments colour sequential driving is not used, and instead each colour transmissive pixel comprises a plurality of differently coloured transmissive sub-pixels, e.g. red, green and blue, as well as each colour reflective pixel comprising a plurality of different coloured reflective sub-pixels, e.g. red, green, blue and white. Different resolution in reflective mode compared to transmissive mode is provided by having more transmissive pixels than reflective pixels. Apart from this, other details are as for the above described embodiments. In other words, each of the above described driving circuits and schemes varying the driving conditions according to the ambient light level for the above described colour sequential driving devices may be embodied instead in transflective LCD devices using a pixel arrangement comprising differently coloured transmissive sub-pixels.

For example, FIG. 11 is a schematic diagram showing the arrangement of sub-pixels in an example of such a transflective LCD device 1 with differently coloured transmissive sub-pixels in which any of the above described driving schemes using ambient light level may be implemented. The transflective LCD device 1 has a large number of transmissive and reflective sub-pixels arranged in an array of rows and columns. For clarity, only four reflective sub-pixels 206a-206d and twelve transmissive sub-pixels 203a-203l are shown by way of example. The transmissive sub-pixels 203a-203l and reflective sub-pixels 206a-206b are arranged in rows and columns, such that respective rows of transmissive sub-pixels 203a-203l alternate with respective rows of reflective sub-pixels 206a-206d. In more detail, reflective sub-pixels 206a and 206b are in a first row, transmissive sub-pixels 203a-203f are in a second row, reflective sub-pixels 206c and 206d are in a third row, and transmissive sub-pixels 203g-203l are in a fourth row. The columnar arrangement of the transmissive sub-pixels is that transmissive sub-pixels 203a and 303g are in a first (“transmissive”) column, transmissive sub-pixels 203b and 203h are in a second column, transmissive sub-pixels 203c and 203i are in a third column, transmissive sub-pixels 203d and 203j are in a fourth column, transmissive sub-pixels 203e and 203k are in a fifth column, and transmissive sub-pixels 203f and 203l are in a sixth column. In this embodiment each reflective sub-pixel (i.e. one quarter of a reflective pixel) is positionally associated with three transmissive sub-pixels (i.e. one transmissive pixel), more particularly each reflective sub-pixel is positioned so as to be positioned across a row to an extent corresponding to the extent of three transmissive sub-pixels across the next row. Thus, each column of reflective sub-pixels corresponds to three columns of transmissive sub-pixels.

In more detail, the reflective sub-pixel 206a and the reflective sub-pixel 206c are in a first (“reflective”) column, with reflective sub-pixel 206a positioned above (in the sense of row number) transmissive sub-pixels 203a-203c and with reflective sub-pixel 206c positioned above (in the sense of row number) transmissive sub-pixels 203g-203i; and the reflective sub-pixel 206b and the reflective sub-pixel 206d are in a second (“reflective”) column, with reflective sub-pixel 206b positioned above (in the sense of row number) transmissive sub-pixels 203d-203f and with reflective sub-pixel 206d positioned above (in the sense of row number) transmissive sub-pixels 203j-203l.

The colours of the sub-pixels are arranged as follows.

The reflective sub-pixels 206a-206d are respectively red, green, blue and white, i.e. the reflective sub-pixel 206a is red, the reflective sub-pixel 206b is green, the reflective sub-pixel 206c is blue, and the reflective sub-pixel 206d is white.

The transmissive sub-pixels are arranged in groups of three sub-pixels along a row, each sub-pixel in a group being a respective one of red, green and blue i.e. transmissive sub-pixel 203a is red, transmissive sub-pixel 203b is green, and transmissive sub-pixel 203c is blue; transmissive sub-pixel 203d is red, transmissive sub-pixel 203e is green, and transmissive sub-pixel 203f is blue; transmissive sub-pixel 203g is red, transmissive sub-pixel 203h is green, and transmissive sub-pixel 203i is blue; transmissive sub-pixel 203j is red, transmissive sub-pixel 203k is green, and transmissive sub-pixel 203l is blue.

The above described colour sub-pixels are grouped to provide colour pixels as follows. Each transmissive colour pixel 204a-204d comprises one red, one adjacent green and one adjacent blue transmissive sub-pixel from the same row of transmissive sub-pixels, i.e. transmissive colour pixel 204a comprises transmissive sub-pixels 203a (red), 203b (green) and 203c (blue); transmissive colour pixel 204b comprises transmissive sub-pixels 203d (red), 203e (green) and 203f (blue); transmissive colour pixel 204c comprises transmissive sub-pixels 203g (red), 203h (green) and 203i (blue); transmissive colour pixel 204d comprises transmissive sub-pixels 203j (red), 203k (green) and 203l (blue) (in FIG. 11 the outline of the colour pixels is shown in bold line, whereas the distinction between respective colour sub-pixels is shown in dashed line). The reflective pixel 212 comprises each of the reflective sub-pixels 206a (red), 206b (green), 206c (blue) and 206d (white). This arrangement, in which the four sub-pixels of the reflective pixel 212 are spread over two rows (as opposed to positioning all the four sub-pixels of a given reflective sub-pixel across a single row), in effect “shares” the lower resolution of the reflective mode between the vertical and the horizontal resolutions, thereby tending to improve the perception of the image to a user.

In this example the resolution in reflective mode is one quarter that in the transmissive mode, i.e. there are four times as many transmissive pixels as there are reflective pixels, which is achieved by providing four “colours” of reflective sub-pixel, i.e. red, green, blue and white. This tends to provide the advantage of being particularly convenient to use with common driving software and arrangements, which typically are provided in resolutions which are scaled by a factor of four.

TFTs (not shown) are located at each reflective sub-pixel 206a-206d and each transmissive sub-pixel 203a-203l, or alternatively may be shared between the reflective sub-pixels 206a-206d and the transmissive sub-pixels 203a-203l, as described above for the various different colour sequential driving embodiments.

The overall structure of the transflective LCD device of this embodiment is the same as that described for the above embodiments with reference to FIG. 2, except that in the present embodiment FIG. 2 shows a cross-section along the line X-Y of FIG. 11, i.e. including two reflective sub-pixels 206b and 206d, with a transmissive sub-pixel 203d therebetween. The items indicated by reference numerals 122, 152, 8, 164 and 4 are essentially as described above, but in this embodiment provide the transmissive sub-pixel 203d. In similar fashion, the two colour filter regions 166 are in this embodiment different colours to each other so that the regions 6 are essentially as described above but in this embodiment provide the two separate reflective sub-pixels 206b and 206d (i.e. unlike in the previous embodiments, where region 4 is a transmissive aperture with a surrounding reflective region 6, here region 4 is a transmissive sub-pixel between two reflective sub-pixels).

Other details of the transflective LCD device, except where otherwise stated in relation to the provision of separate reflective sub-pixels and transmissive sub-pixels, and the driving thereof, again may be as per any conventional transflective LCD device, and are in the present embodiment the same as, and operate the same as, the transflective LCD device disclosed with reference to FIG. 2 of U.S. Pat. No. 6,734,935, the contents of which are contained herein by reference.

In the above embodiments, the reflective mode image differs from the transmissive mode by virtue of being of different resolution. However, this is not the only image difference encompassed by the present invention, and in other embodiments the reflective mode image may differ from the transmissive mode in some other way. Apart from this, other details are as for the above described embodiments. In other words, each of the above described driving circuits and schemes varying the driving conditions according to the ambient light level for the above described different resolution devices may be embodied instead in transflective LCD devices with other differences between the reflective mode image and the transmissive mode image.

For example, FIG. 12 is a schematic diagram showing the arrangement of pixels in an example of a transflective LCD device 1 in which the transmissive mode image is colour and the reflective mode image is monochrome. The transflective device 1 is the same as the earlier described embodiments, except for the following details.

The transflective LCD device 1 comprises a large number of transmissive pixels/reflective pixel pairs 402 arranged in an array of rows and columns, in this example 130 rows by 390 columns (for clarity only some of these are shown in FIG. 12). Each transmissive pixel/reflective pixel pair 402 comprises a transmissive pixel 4 surrounded by a reflective pixel 406. Each transmissive pixel 4 is in effect a colour pixel by virtue of the backlight 190 being driven in colour sequential mode. Thus the image displayed in the transmissive mode is a colour image. Each of the reflective pixels is white.

Thus the image displayed in the reflective mode is black and white, i.e. monochrome (note any other single colour could be used, e.g. a monochrome green image could be displayed, making use of the eye's increased sensitivity to green light).

TFTs (not shown) are located at each reflective pixel 406 and each transmissive pixel 4, or alternatively may be shared between the reflective pixels 406 and the transmissive pixels 4, as described above for the various other colour sequential driving embodiments.

Other details of the transflective LCD device 1, except where otherwise stated in relation to the provision of colour transmissive mode and monochrome reflective mode, and the driving thereof, again may be as per any conventional transflective LCD device, and are in the present embodiment the same as, and operate the same as, the transflective LCD device disclosed with reference to FIG. 2 of U.S. Pat. No. 6,734,935, the contents of which are contained herein by reference.

In other embodiments, the processor 102 may additionally adapt the column driver data 112 and/or the row driver control signal 113 such that whenever the backlight is switched off a form of the image adapted for display in the reflective mode is provided, and/or such that whenever the reflective mode is driven in all-black state a from of the image adapted for display in the transmissive mode is provided.

In the above embodiments, a relatively large change in brightness occurs when switching the backlight on or off and/or when switching the reflective mode between all-black mode and image display mode. In other embodiments, the reflective pixels are driven with identical image content (except, e.g. different resolution) as the transmissive pixels. This tends to allow a smoother transition from transmissive to reflective images, with e.g. less artifacts in the transition region.

In the above embodiments, the transflective LCD device comprises a display panel and separate photodiode housed in a single housing. However, the display panel and photodiode may be arranged or housed in any suitable manner, and may be provided as quite separate entities or components. For example the invention may be implemented by installing a display panel as one component in an item of electrical apparatus, and a separate e photodiode as another separate component thereof, e.g. installed separately in e.g. a mobile telephone. Another possibility is for a photodiode to be integrated in the semiconductor structure providing the array of pixels.

In the above embodiments, a photodiode and associated circuitry is used to provide sensing of the ambient light level. However, in other embodiments, other means for sensing the ambient light level may be employed.

In the above embodiments some of the processing of the ambient light levels is implemented by the so-called “ambient light level module”. This module may be implemented in any suitable form. Furthermore the module may be located other with the main driving circuitry of the display device. For example, such a module may be implemented in a separate processor located elsewhere in an end-use apparatus.

In the above embodiments, the ambient light level module s coupled to the general processor which sends control signals to the backlight for switching the backlight on and off. However, especially for embodiments where the backlight is not being driven in colour sequential drive mode, then the ambient light level module need not be connected to the processor 102 and can instead be coupled directly to the backlight. The ambient light level module then carries out comparison of the ambient light level to the thresholds itself, and provides instructions directly to the backlight for switching the backlight on and off.

The backlight may be implemented in any suitable manner. For example, the backlight may be physically spread over the area of the display panel, or may, for example, alternatively comprise a light source with plural guiding channels guiding light to specific pixels or groups of pixels.

In the above embodiments, hysteresis loops are provided by having two thresholds spaced apart. However, in other embodiments, just a single threshold may be employed, which would sometimes be simpler to implement, although this would be at the expense of a trade-off with allowing frequent switching between modes when the ambient light level is about the level of the threshold and/or when noise is prevalent.

The invention may be implemented with different pixel arrangements other than those described for the above embodiments. For example, the reflective pixels may comprise e.g. three colours of sub-pixel, e.g. red, green and blue, or e.g. four colours of sub-pixel, e.g. red, green, blue and white. Also, different driving schemes, in particular arrangements for sharing TFTs and row and/or column conductors, may be used.

In the above embodiments, the way a corresponding image displayed the reflective mode and transmissive modes differs in at least one characteristic is either by way of the transmissive mode being of greater resolution than the reflective mode, or by way of the transmissive image being colour and the reflective image being monochrome. Firstly, in other embodiments, both or either of these may be reversed, i.e. the reflective mode may be of greater resolution than the transmissive mode; similarly the reflective mode may be colour and the transmissive mode monochrome. More generally, there may be more than one such characteristic, e.g. there may be differing resolution and colour between reflective mode and transmissive mode. Also, generally, the present invention may be implemented in other embodiments wherever there is one or more characteristics that vary between the reflective and transmissive mode such that mixed images tend to be perceived by a user at “medium” light levels. One example is that of the transmissive modes and reflective modes being driven at different frame rates.

1. A transflective display device, comprising:
an array of transmissive pixels (4) and reflective pixels (12) arranged such that at least one characteristic of an image is different for the image displayed in transmissive mode compared to the image displayed in reflective mode; and
means arranged to vary the relative image brightness between the transmissive mode and the reflective mode dependent upon the ambient light level (304) when compared to one or more ambient light level thresholds (316, 318).

2. A device according to claim 1, wherein the means arranged to vary the relative image brightness between the transmissive mode and the reflective mode comprises means arranged to switch off a backlight (190) that provides illumination for the transmissive mode responsive to the ambient light level exceeding a first threshold (316).

3. A device according to claim 2, wherein the backlight (190) is switched on when the ambient light level (304) falls below the first threshold (316).

4. A device according to claim 2, wherein the backlight (190) is switched on when the ambient light level (304) falls below a second threshold (318), the second threshold (318) being lower than the first threshold (316), thereby providing a hysteresis loop (320-321).

5. A device according to claim 2, wherein the means arranged to vary the relative image brightness between the transmissive mode and the reflective mode further comprises means for driving the reflective pixels in an all-black state responsive to the ambient light level (304) falling below the first threshold (316).

6. A device according to claim 4, wherein the means arranged to vary the relative image brightness between the transmissive mode and the reflective mode further comprises means for driving the reflective pixels in an all-black state responsive to the ambient light level (304) falling below the second threshold (318), and the reflective pixels are driven in image display mode when the ambient light level (304) exceeds the first threshold (316).

7. A device according to claim 1, wherein the means arranged to vary the relative image brightness between the transmissive mode and the reflective mode comprises means for driving the reflective pixels in an all-black state responsive to the ambient light level (304) falling below a second threshold (318).

8. A device according to claim 7, wherein the reflective pixels are driven in image display mode when the ambient light level (304) exceeds the second threshold (318).

9. A device according to claim 7, wherein the reflective pixels are driven in image display mode when the ambient light level (304) exceeds a first threshold (316), the first threshold (316) being higher than the second threshold (318) thereby providing a hysteresis loop (322-323).

10. A device according to claim 1, wherein the at least one characteristic comprises the image displayed in transmissive mode being of different resolution to that of the corresponding image displayed in reflective mode.

11. A device according to claim 1, wherein the at least one characteristic comprises the image displayed in transmissive mode being one of colour or monochrome and the corresponding image displayed in reflective mode being the other of colour or monochrome.

12. A transflective display device, comprising:
an array of transmissive pixels (4) and reflective pixels (12) arranged such that at least one characteristic of an image is different for the image displayed in transmissive mode compared to the image displayed in reflective mode; and
means arranged to switch off a backlight (190) that provides illumination for the transmissive mode responsive to the ambient light level (304) exceeding a first threshold (316).

13. A device according to claim 12, further comprising means for driving the reflective pixels in an all-black state responsive to the ambient light level (304) falling below the first threshold (316).

14. A transflective display device, comprising:
an array of transmissive pixels (4) and reflective pixels (12) arranged such that at least one characteristic of an image is different for the image displayed in transmissive mode compared to the image displayed in reflective mode; and
means for driving the reflective pixels (12) in an all-black state responsive to the ambient light level (304) falling below a first threshold (316).

15. A device according to claim 12, wherein the at least one characteristic comprises the image displayed in transmissive mode being of different resolution to that of the corresponding image displayed in reflective mode.

16. A device according to claim 12, wherein the at least one characteristic comprises the image displayed in transmissive mode being one of colour or monochrome and the corresponding image displayed in reflective mode being the other of colour or monochrome.
